(19) United States
(12) Patent Application Publication
(10) Pub. No.: US 2026/0085548 A1
(43) Pub. Date: Mar. 26, 2026

(54) AUTO-OPEN DOOR LOCK DEVICE

(71) Applicant: Dual Power Electronics Co., Ltd, Jeongeup-si (KR)

(72) Inventors: Jang-Joo LIM, Seoul (KR); Sang-Won Suh, Jeongeup-si (KR); Jung Gil Lee, Jeongeup-si (KR); Hee Chang Kim, Jeongeup-si (KR)

(21) Appl. No.: 19/403,678

(22) Filed: Nov. 28, 2025

Related U.S. Application Data
(63) Continuation of application No. PCT/KR2024/007564, filed on Jun. 3, 2024.

(30) Foreign Application Priority Data
Jun. 16, 2023 (KR) 10-2023-0077348

(51) Int. Cl. E05B 47/02; E05B 65/44

(52) U.S. Cl. CPC E05B 47/023; E05B 65/44

(57) ABSTRACT

An auto-open door lock device according to an embodiment of the present invention is an auto-open door lock device comprising a locking set that operates to engage with and release a hook installed on a door, and a control set that provides power to the locking set, wherein the locking set includes a locker that fixes the hook and receives a rotational force in a first direction about a first center, a latch that receives a rotational force in a second direction about a second center attached to one side, and a locking lever provided with a locking flange that fixes the locker to implement a locked state, and the control set includes a first motor that operates the locking lever, a first micro switch that determines whether the first motor rotates, a second motor that operates the latch, and a second micro switch that determines whether the second motor rotates, and the locking set and the control set are separated from each other.

### CROSS-REFERENCE TO RELATED APPLICATIONS

This present application is a Continuation of International Patent Application No. PCT/KR2024/007564, filed on June 3, 2024, which is based upon and claims the benefit of priority to Korean Patent Application No. 10-2023-0077348 filed on June 16, 2023. The disclosures of the above-listed applications are hereby incorporated by reference herein in their entirety.

### TECHNICAL FIELD

The present invention relates to an auto-open door lock device, and more particularly, to an auto-open door lock device used in home appliances such as ovens and microwave ovens.

### RELATED ART

There are various types of home appliances in our daily lives. In particular, a home appliance that is used by inserting contents, for example, a washing machine, a dryer, a dishwasher, a microwave oven, and the like, is installed with a door to block the inserted contents from the outside. A locking device that opens and closes the door is an essential part that constitutes the corresponding home appliance.

Until recently, various techniques related to a door-lock device are developed. Representative examples include Korean Patent Registration No. 10-1667916 (Door-lock apparatus for push and push) and Korean Patent Registration No. 10-1915250 (Manual door-lock device).

The door-lock apparatus for push and push relates to a door-lock device that automatically opens a door without a need for a user to open the door when an operation of a corresponding home appliance is terminated.

The door-lock apparatus for push and push includes a release button installed inside a body and configured to release a locked locker by releasing a binding force of a fastening member through a sliding operation and a driving unit configured to selectively control a door holding operation, a door locking operation, and an automatic door opening operation by a rotational operation of a rotational shaft with a cam protrusion on one side. However, the above device has the complicated overall configuration and control since the driving unit and a sensing member detect a locking or unlocking operation of the locker by detecting a position of the cam protrusion.

The manual door-lock device relates to a door-lock device that may be manually operated with a simple structure, which differs from an existing method that is electronically operated by a solenoid.

Push-and-push door lock devices used in home appliances have a complicated operation process, and malfunctions frequently occur due to excessive force applied to the torsion spring. Manual door lock devices have device stability, but are inconvenient in that the door lock is opened and closed by human operation, and irregular force is applied to the device, which also causes malfunctions.

Therefore, there is a need for a door lock device that achieves organic coupling between components and implements various functions.

### DETAILED DESCRIPTION

### TECHNICAL SUBJECT

An object of the present invention is to provide an auto-open door lock device that can be applied to home appliances such as ovens and microwave ovens.

Another object is to provide an auto-open door lock device that has almost no device malfunctions and can be implemented in a compact size.

Another object is to provide an auto-open door lock device with excellent durability in which the connection between components constituting the device is organic and the movement clearance of the components is not large.

### TECHNICAL SOLUTION

An auto-open door lock device according to an embodiment of the present invention is an auto-open door lock device comprising a locking set that operates to engage with and release a hook installed on a door, and a control set that provides power to the locking set, wherein the locking set includes a locker that fixes the hook and receives a rotational force in a first direction about a first center, a latch that receives a rotational force in a second direction about a second center attached to one side, and a locking lever provided with a locking flange that fixes the locker to implement a locked state, and the control set includes a first motor that operates the locking lever, a first micro switch that determines whether the first motor rotates, a second motor that operates the latch, and a second micro switch that determines whether the second motor rotates, and the locking set and the control set are separated from each other.

In an embodiment, the locking lever is moved by rotation of a first bridge connected to the first motor by a first line, and the latch performs a lifting operation by rotation of a second bridge connected to the second motor by a second line.

In an embodiment, the locker includes a seating portion formed by a first ring and a second ring to which the hook is fastened, an engaging portion protruding from a lower portion of the second ring, an engaging piece having a bent shape at one end of the engaging portion, and a groove portion having a recessed shape on an outer edge, and the latch includes a first inclined surface that is an edge formed toward the locker, a second inclined surface that is an edge formed toward the locker and separated from the first inclined surface at a different height, a receiving portion in which the engaging piece is accommodated to fix the locker, and a protruding piece having a shape obliquely bent at one edge of the receiving portion.

In an embodiment, the second bridge includes a lifting protrusion having an edge protruding in an oblique form that lifts and lowers a certain region of the latch.

In an embodiment, the operation of the first motor is controlled to maintain a locked state when a temperature is equal to or higher than a predetermined first reference temperature by a temperature sensor.

In an embodiment, the operation of the second motor is controlled to automatically open the door when a temperature is equal to or lower than a predetermined second reference temperature by a temperature sensor.

### EFFECT

An auto-open door lock device according to an embodiment of the present invention can be implemented in a compact size and can be installed in various home appliances.

In addition, a stable auto-open door lock device with fewer malfunctions is provided due to organic coupling between components.

In addition, the load acting on the device due to pushing is limited, thereby reducing the risk of device malfunction.

In addition, components installed in a heating area and components installed in a non-heating area are separately installed, so there is no risk of malfunction due to heat.

### BRIEF DESCRIPTION OF DRAWINGS

FIG. 1 is a plan view of an auto-open door lock device according to an embodiment of the present invention.

FIG. 2 is an actual installation view of an auto-open door lock device according to an embodiment of the present invention.

FIGS. 3 and 4 are plan views of a locking set according to an embodiment of the present invention.

FIG. 5 is a state diagram at a point in time when the hook is fastened to the seating portion.

FIG. 6 is a state diagram at a point in time when the hook pushes the second ring.

FIG. 7 is a state diagram when the locker is closed.

FIG. 8 is a state diagram when closing of the locker is completed.

FIG. 9 is a state diagram when the locker starts to separate from the latch.

FIG. 10 is a state diagram when separation of the locker and the latch is completed.

FIGS. 11 and 12 are auto-open operation state diagrams.

### MODE

Specific structural or functional descriptions of embodiments according to the concept of the present invention disclosed in this specification are merely illustrated for the purpose of explaining embodiments according to the concept of the present invention, and embodiments according to the concept of the present invention may be implemented in various forms and are not limited to the embodiments described in this specification.

Since embodiments according to the concept of the present invention can have various modifications and various forms, the embodiments are illustrated in the drawings and will be described in detail in this specification. However, this is not intended to limit the embodiments according to the concept of the present invention to specific disclosed forms, and includes all modifications, equivalents, or substitutes included in the spirit and technical scope of the present invention.

Terms such as first or second may be used to describe various components, but the components should not be limited by the terms. The terms are only for the purpose of distinguishing one component from another component, for example, without departing from the scope of rights according to the concept of the present invention, a first component may be referred to as a second component, and similarly, a second component may also be referred to as a first component.

When a component is referred to as being "connected" or "coupled" to another component, it may be directly connected or coupled to the other component, but it should be understood that other components may exist in between. On the other hand, when a component is referred to as being "directly connected" or "directly coupled" to another component, it should be understood that no other components exist in between. Other expressions describing relationships between components, such as "between" and "directly between" or "adjacent to" and "directly adjacent to," should be interpreted in the same manner.

"The terminology used in this specification is only used to describe specific embodiments and is not intended to limit the present invention. Singular expressions include plural expressions unless the context clearly indicates otherwise. In this specification, terms such as "comprise" or "have" are intended to designate the presence of features, numbers, steps, operations, components, parts, or combinations thereof described in this specification, and it should be understood that they do not preclude in advance the presence or addition possibility of one or more other features, numbers, steps, operations, components, parts, or combinations thereof.

Unless otherwise defined, all terms used herein, including technical or scientific terms, have the same meaning as commonly understood by a person having ordinary skill in the technical field to which the present invention belongs. Terms such as those defined in commonly used dictionaries should be interpreted as having meanings consistent with the meanings they have in the context of the related art, and are not interpreted in an idealized or overly formal sense unless clearly defined in this specification.

Hereinafter, embodiments of the present invention will be described in detail with reference to the drawings attached to this specification. However, the scope of the patent application is not limited or restricted by these embodiments. The same reference numerals presented in each drawing indicate the same members.

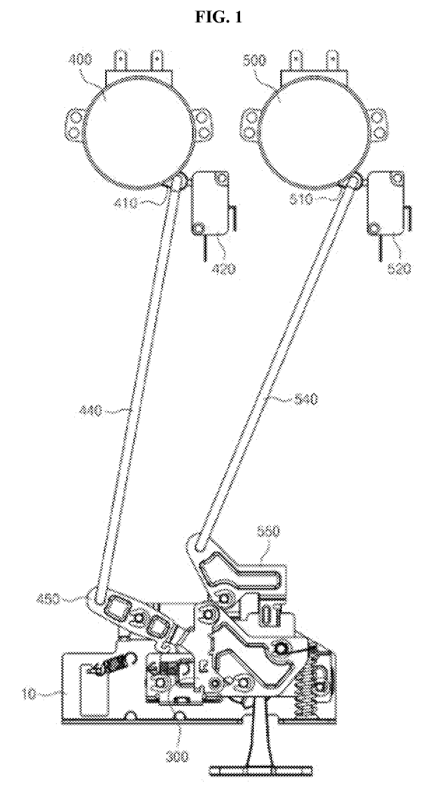

FIG. 1 is a plan view of an auto-open door lock device according to an embodiment of the present invention.

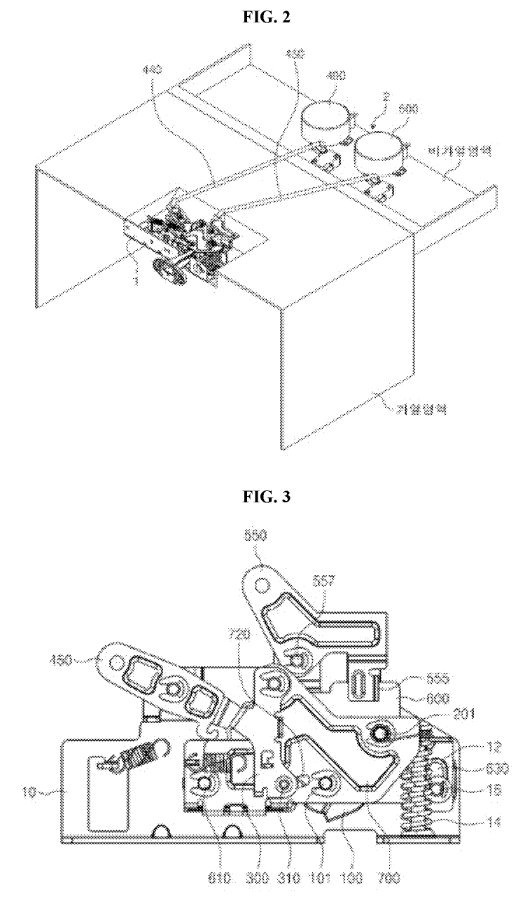

FIG. 2 is an actual installation view of an auto-open door lock device according to an embodiment of the present invention.

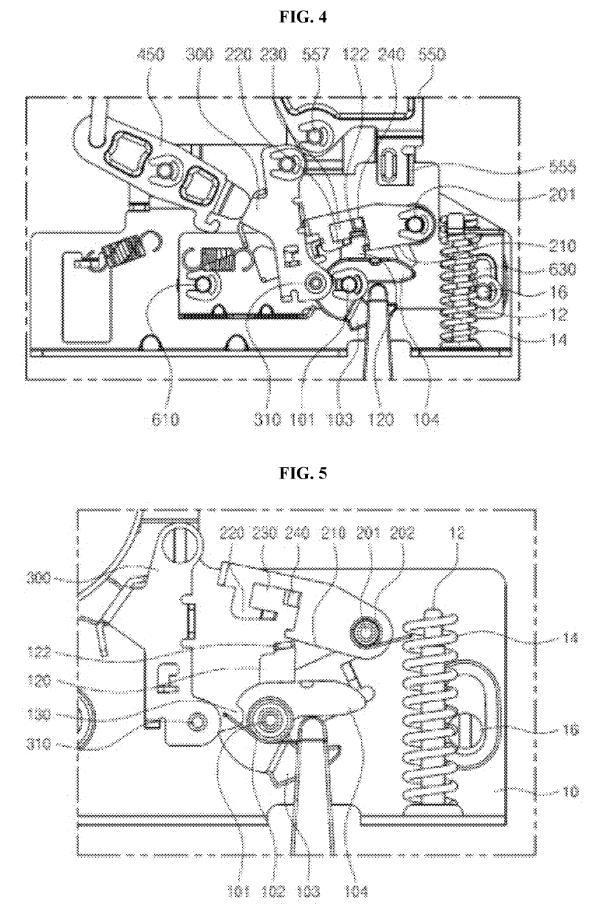

FIGS. 3 and 4 are plan views of a locking set according to an embodiment of the present invention.

An auto-open door lock device according to an embodiment of the present invention is an auto-open door lock device comprising a locking set (1) that operates to engage with and release a hook (20) installed on a door, and a control set (2) that provides power to the locking set (1), wherein the locking set (1) includes a locker (100) that fixes the hook (20) and receives a rotational force in a first direction about a first center (101), a latch (200) that receives a rotational force in a second direction about a second center (201) attached to one side, and a locking lever (300) provided with a locking flange (310) that fixes the locker (100) to implement a locked state, and the control set (1) includes a first motor (400) that operates the locking lever (300), a first micro switch (420) that determines whether the first motor (400) rotates, a second motor (500) that operates the latch (200), and a second micro switch (520) that determines whether the second motor (500) rotates, and the locking set (1) and the control set (2) are separated from each other.

The auto-open door lock device according to an embodiment of the present invention, which is divided into a locking set (1) and a control set (2), installs components of the control set (2) that are vulnerable to heat in a non-heating area as shown in FIG. 2, so that the entire auto-open door lock device does not malfunction due to heat.

The locking set (1) and the control set (2) are connected by a first line (440) and a second line (540) as shown in FIG. 1. The first line (440) and the second line (540) may be beams made of heat-resistant metal material, but are not necessarily limited thereto, and any means capable of connecting the movements of the first motor (400) and the second motor (200) to the first bridge (450) and the second bridge (550) of the locking set (1) while ensuring heat resistance can be adopted.

The locking lever (300) is moved by rotation of a first bridge (450) connected to the first motor (400) by a first line (440), and the latch (200) performs a lifting operation by rotation of a second bridge (550) connected to the second motor (500) by a second line (540).

Furthermore, the operation of the first motor (400) is controlled to maintain a locked state when the temperature is equal to or higher than a predetermined first reference temperature by a temperature sensor, and the operation of the second motor (500) is controlled to automatically open the door when the temperature is equal to or lower than a predetermined second reference temperature by a temperature sensor.

The first reference temperature and the second reference temperature may be previously set temperatures or the set values may be changed by the user.

FIG. 5 is a state diagram at a point in time when the hook (20) is fastened to the seating portion (110).

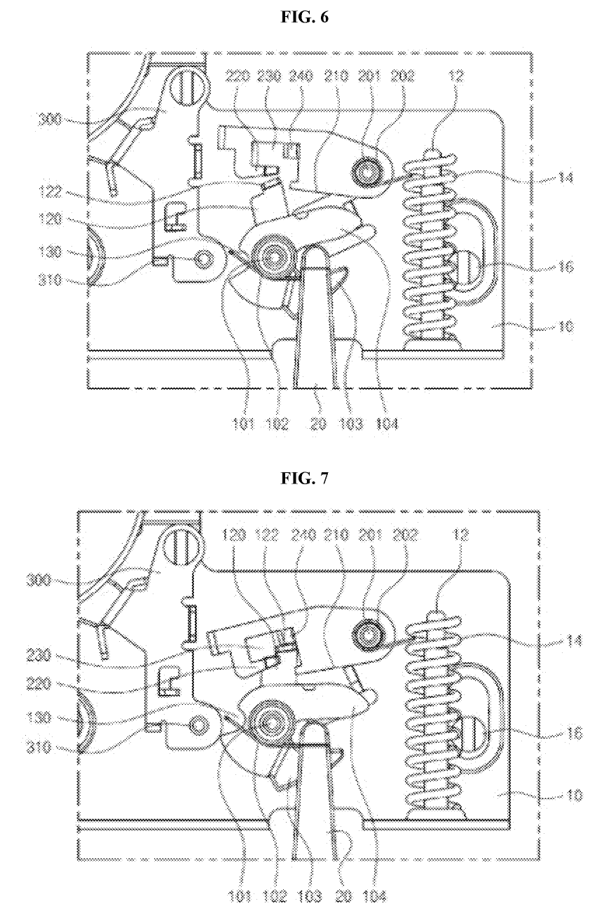

FIG. 6 is a state diagram at a point in time when the hook (20) pushes the second ring (104).

FIG. 7 is a state diagram when the locker (100) is closed.

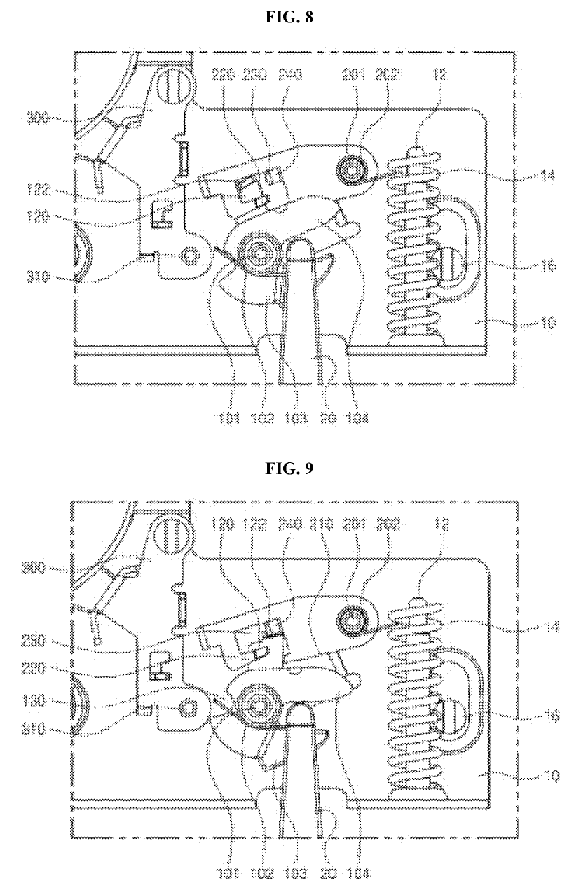

FIG. 8 is a state diagram when closing of the locker (100) is completed.

FIG. 9 is a state diagram when the locker (100) starts to separate from the latch (200).

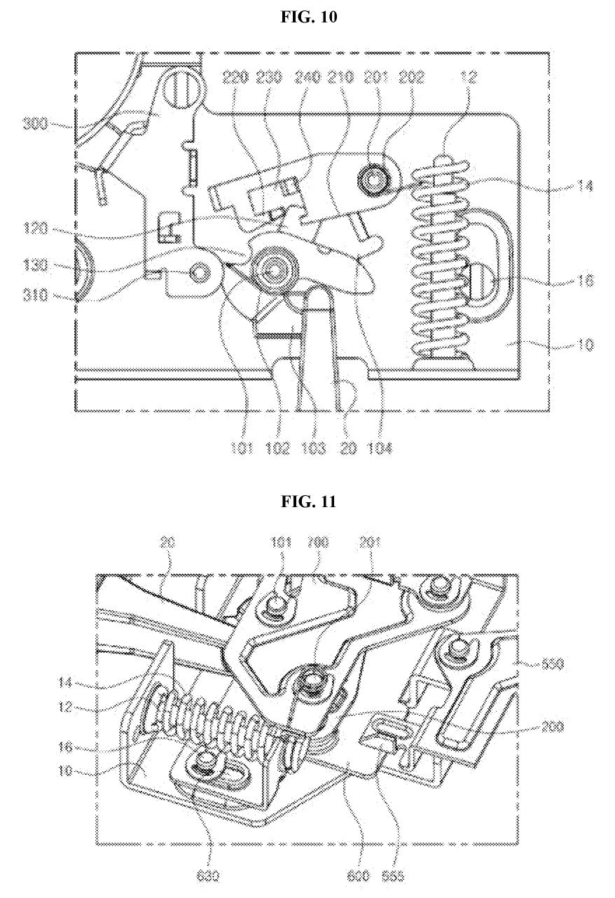

FIG. 10 is a state diagram when separation of the locker (100) and the latch (200) is completed.

As shown in FIGS. 3 and 4, the auto-open door lock device according to an embodiment of the present invention includes a locker (100) that fixes the hook (20), has a first torsion spring (102) installed at a first center (101) and receives a rotational force in a first direction, and a latch (200) that rotates about a second center (201) attached to one side, has a second torsion spring (202) installed and receives a rotational force in a second direction.

The first direction may mean clockwise rotation and the second direction may mean counterclockwise rotation, but is not necessarily limited thereto.

The auto-open door lock device shown in FIGS. 3 and 4 may be formed by directly or indirectly attaching internal components to a base (10).

The base (10), locker (100), and latch (200) constituting the auto-open door lock device according to an embodiment of the present invention may be made of hard metal material, but are not necessarily limited thereto and may be made of hard plastic material.

In addition, it is preferable that the material is resistant to heat depending on the function of the home appliance in which the door lock device is installed.

The locker (100) according to an embodiment of the present invention continuously receives rotational force in the clockwise direction by the first torsion spring (102). When the hook (20) flows into the locker (100), the locker (100) is forced to rotate in the counterclockwise direction, which is opposite to the rotational force in the clockwise direction. Of course, it is expected that the locker (100) will rotate counterclockwise as the hook (20) flows in with an external force stronger than the rotational force of the first torsion spring (102).

More specifically, the locker (100) includes a seating portion (110) formed by a first ring (103) and a second ring (104), an engaging portion (120) protruding from a lower portion of the second ring (104), an engaging piece (122) having a bent shape at one end of the engaging portion (120), and a groove portion (130) having a recessed shape on an outer edge.

The seating portion (110) is a portion to which the hook (20) flows in and is fastened. Although it is formed in a U-shape in FIGS. 3 and 4, there is no limitation on the shape, and it can be implemented in various forms to which the hook (20) flowing in from the outside can be fastened.

It is preferable that the first ring (103) and the second ring (104) are formed integrally. When forming the seating portion (110), the lengths of the first ring (103) and the second ring (104) may be different from each other.

The locker (100) according to an embodiment of the present invention includes an engaging portion (120). The engaging portion (120) is formed to protrude from the lower portion of the second ring (104). It is preferable that the engaging portion (120) is manufactured integrally with the first ring (103) and the second ring (104) so that it can rotate simultaneously with the rotation of the first ring (103) and the second ring (104).

In addition, as shown in FIGS. 3 and 4, an engaging piece (122) having a bent shape is formed at one end of the engaging portion (120). The engaging piece (122) is located at an edge of the engaging portion (120) and has a shape bent in a direction opposite to the base (10).

It is preferable that the engaging piece (122) is manufactured integrally with the engaging portion (120) in a solid and firm manner as a region that controls the movement of the locker (100) by the latch (200).

Furthermore, a groove portion (130) having a recessed shape is formed on an outer edge of the locker (100). As shown in FIGS. 3 and 4, the groove portion (130) may be formed in a recessed shape to a predetermined depth on an outer periphery at a point where the first ring (103) and the second ring (104) meet, but is not necessarily limited thereto.

The latch (200) according to an embodiment of the present invention continuously receives a rotational force in a direction opposite to the first direction, which is the rotational direction of the locker (100), and the cause is the second torsion spring (202) attached to one end of the latch (200).

As shown in FIGS. 3 and 4, the latch (200) according to an embodiment of the present invention includes a first inclined surface (210) that is an edge formed toward the locker (100), a second inclined surface (220) that is an edge formed toward the locker (100) and separated from the first inclined surface (210) at a different height, a receiving portion (230) in which the engaging piece (122) is accommodated to fix the locker (100), and a protruding piece (240) having a bent shape at one edge of the receiving portion (230).

The first inclined surface (210) formed on the latch (200) is formed toward the locker (100). More specifically, the edge of the latch (200) on which the engaging piece (122) rides and moves by the rotation of the locker (100) is the first inclined surface (210).

The second inclined surface (220) is an edge formed toward the locker (100) like the first inclined surface (210), and more specifically, is an inclined surface on which the engaging piece (122) is seated by the rotation of the locker (100), similar to the first inclined surface (210). The second inclined surface (220) is separated from the first inclined surface (210), and the height at which the first inclined surface (210) is formed and the height at which the second inclined surface (220) is formed are different from each other. Furthermore, as shown in FIGS. 1 and 2, the height at which the second inclined surface (220) is formed is designed to be lower than the height at which the first inclined surface (210) is formed.

The latch (200) according to an embodiment of the present invention includes a receiving portion (230), which is a space opened in a hook shape, with only an edge region consisting of the first inclined surface (210) and the second inclined surface (220) being opened.

As shown in FIGS. 3 and 4, the receiving portion (230) is a space in which the engaging piece (122) is accommodated to fix the locker (100). The engaging piece (122) moves in the receiving portion (230), allowing the latch (200) to engage with or separate from the locker (100). A more detailed description will be provided later.

The latch (200) according to an embodiment of the present invention includes a protruding piece (240) having a bent shape at one edge of the receiving portion (230). As shown in FIGS. 3 and 4, the protruding piece (240) has a shape obliquely bent toward the opposite side of the base (10). That is, the protruding piece (240) has a bent shape as if a slope is formed with respect to an imaginary surface of the latch (200) formed by the receiving portion (230).

Each configuration of the latch (200) may refer to a detailed configuration portion of the latch (200) formed integrally.

The auto-open door lock device according to an embodiment of the present invention includes a locking lever (300) provided with a locking flange (310) that is moved by the first motor (400) and engages with the groove portion (130).

The locking lever (300) has one end coupled to the base (10) and rotates, and is pushed and moved by the first motor arm (410) so that the locking flange (310) moves toward the locker (100), and the locking flange (310) engages with the groove portion (130) to prevent the locker (100) from rotating.

In addition, as the locking lever (300) is moved by the first bridge (450), the first motor arm can press the first micro switch (420) to confirm that the locker (100) is in a locked state.

In particular, ovens periodically perform a heating and cleaning process to heat oil adhering to the oven to a temperature of 300 degrees or higher and blow it into the air during cooking, and in performing this process, the oven door must automatically maintain a locked state so that it does not open.

At this time, as shown in FIGS. 2 and 3, the first motor (400) rotates and the first motor arm (410) pulls the first line (440), and pushes the locking lever (300) with the first bridge (450) so that the locking flange is inserted into the groove portion (130) of the locker (100), and simultaneously the first motor arm (410) presses the first micro switch (420) to confirm that the locker (100) is locked.

As shown in FIGS. 3 and 4, in the auto-open door lock device according to an embodiment of the present invention, the second motor (500) is connected to the second bridge (550) through the second line (540). The second bridge (550) rotates about the fifth center (557) so that the lifting protrusion (555) of the second bridge (550) penetrates under the latch (200) and lifts the latch (200). Detailed operation for auto-open will be described later.

As shown in FIGS. 3 and 4, the auto-open door lock device according to an embodiment of the present invention includes a housing bracket (600) and a separate bracket (700).

The housing bracket (600) has a space formed therein in which the locker (100) and the latch (200) are mounted, and is connected to the base (10), a fourth center (610), and a fixing member (16).

In addition, one end of a spring (14) coupled to an outer circumferential surface of a fixing rod (12) fixed to the base (10) is coupled to an upper portion of one side of the housing bracket (600), and a fixing member (16) formed nearby engages with a housing track (630) formed in the housing bracket (600) so that the housing bracket (600) can rotate at a predetermined angle along the housing track (630) about the fourth center (610).

The auto-open door lock device has a problem in that the door cannot be opened if a malfunction occurs while the door is closed. In this case, when the door is pulled with a relatively strong force, the locker (100) is pulled by the hook (20), and the locker (100) is caught by an engaging protrusion formed in the housing bracket (600).

When the door is pulled by applying additional external force, the housing bracket (600) rotates about the fourth center (610). When pulled with a strong force that can overcome the elastic force of the spring (14) on the opposite side of the fourth center (610), the fixing member (16) rises along the housing track (630), causing the locker (100) to rotate, and the hook (20) is released from the first ring (103) of the locker (100).

That is, by configuring the housing bracket (600) as in the embodiment of the present invention, the locker (100) and the hook (20) can be separated in an emergency.

A separate bracket (700) is attached to the opposite side of the housing bracket (600). A flange track (720) through which the aforementioned locking flange (310) can move is formed on a side surface of the separate bracket (700).

The configuration of the auto-open door lock device according to an embodiment of the present invention has been described above. Hereinafter, the closing process to the opening process through pushing of the auto-open door lock device according to an embodiment of the present invention will be described through FIGS. 5 to 10.

As shown in FIG. 5, until the moment when the hook (20) is caught by the seating portion (110) of the locker (100), the hook (20) pushes and rotates the locker (100) in the counterclockwise direction. As the engaging portion (120) of the locker (100) rotates together, the engaging piece (122) of the engaging portion contacts the first inclined surface (210) of the latch (200) and rotates the latch (200) in the clockwise direction.

As shown in FIG. 6, when the hook (20) further pushes the second ring (104), the engaging piece (122) moves to the second inclined surface (220), and the latch (200) moves in the counterclockwise direction by the second torsion spring (202). The locker (100) continuously receives elastic force in the clockwise direction by the first torsion spring (102). When the locker (100) rotates in the clockwise direction while the second inclined surface (220) and the engaging piece (122) are in contact as shown in FIG. 6, the engaging piece (122) flows into a space of the receiving portion (230) formed in the latch (200).

As shown in FIG. 7, when the engaging piece (122) of the locker (100) flows into the receiving portion (230), the engaging piece (122) is seated on the protruding piece (240) of the latch (200).

According to FIG. 7, the hook (20) is in a process of being caught by the locker (100) and closing. By the rotational force in the first direction of the locker (100) and the rotational force in the second direction of the latch (200), as shown in FIG. 8, the engaging piece (122) is seated in the receiving portion (230) of the latch (200), and the door is in a closed state.

When the door is pushed in the closed state, the hook (20) pushes the second ring (104), and as shown in FIG. 9, the engaging piece (122) slides on the protruding piece (240) having an obliquely bent shape, and the engaging piece (122) comes out from behind the latch (200).

When separation of the locker (100) and the latch (200) is completed, as shown in FIG. 10, the locker (100) rotates to an open state, and the hook (20) is released from the seating portion (110) of the locker (100), causing the door to open.

The auto-open door lock device according to an embodiment of the present invention can be opened by pushing using a mechanical shape and rotational force by a torsion spring.

As such, the auto-open door lock device according to an embodiment of the present invention can be opened by pushing the door when cooking starts or when cooking ends. In addition, the door lock device can be automatically released and opened when cooking ends.

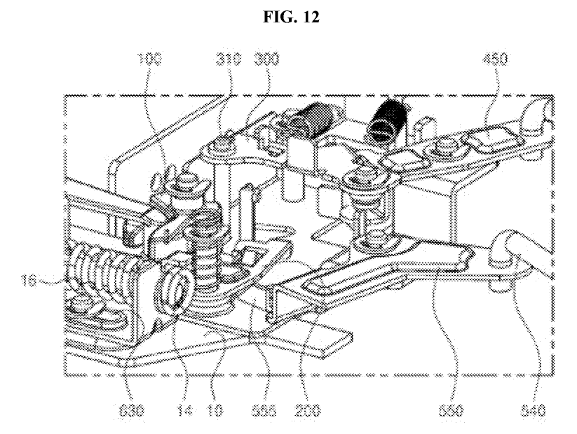

FIGS. 11 and 12 are auto-open operation state diagrams.

As shown in FIG. 11, the second bridge (550) includes a lifting protrusion (555) having an edge protruding in an oblique form that lifts and lowers a certain region of the latch (200). FIG. 11 shows the oblique line of the lifting protrusion (555) facing toward the latch (200), and the engaging piece (122) is accommodated in the internal receiving portion (230) of the latch (200), so that the hook (20) is accommodated in the seating portion (110) of the locker (100) and is in a closed state.

When the second motor (500) in FIG. 1 operates to pull the second line (540) and pull the second bridge (550), the second bridge (550) rotates about the fifth center (557), and the lifting protrusion (555) rides under the latch (200) and pushes up to induce the engaging piece (122) in the receiving portion (230) of the latch (200) to come out.

When the engaging piece (122) comes out of the receiving portion (230) of the latch (200), it rotates by the restoring force in the first direction of the locker (100), and the hook (20) comes out, opening the door.

Although the present invention has been described with reference to the embodiments shown in the drawings, this is merely exemplary, and those having ordinary skill in the art will understand that various modifications and equivalent other embodiments are possible therefrom. For example, even if the described techniques are performed in a different order than the described method, and/or components of the described systems, structures, devices, circuits, etc. are combined or combined in a different form than the described method, or are replaced or substituted by other components or equivalents, appropriate results can be achieved. Therefore, the true technical protection scope of the present invention should be determined by the technical spirit of the appended claims.

What is claimed is

1. An auto-open door lock device comprising a locking set that operates to engage with and release a hook installed on a door, and a control set that provides power to the locking set,
wherein the locking set includes:
a locker that fixes the hook and receives a rotational force in a first direction about a first center;
a latch that receives a rotational force in a second direction about a second center attached to one side; and
a locking lever provided with a locking flange that fixes the locker to implement a locked state,
wherein the control set includes:
a first motor that operates the locking lever;
a first micro switch that determines whether the first motor rotates;
a second motor that operates the latch; and
a second micro switch that determines whether the second motor rotates,
wherein the locking set and the control set are separated from each other.

2. The door lock device of claim 1, wherein the locking lever is moved by rotation of a first bridge connected to the first motor by a first line, and the latch performs a lifting operation by rotation of a second bridge connected to the second motor by a second line.

3. The door lock device of claim 1, wherein the locker includes:
a seating portion formed by a first ring and a second ring to which the hook is fastened;
an engaging portion protruding from a lower portion of the second ring;
an engaging piece having a bent shape at one end of the engaging portion; and
a groove portion having a recessed shape on an outer edge,
wherein the latch includes:
a first inclined surface that is an edge formed toward the locker;
a second inclined surface that is an edge formed toward the locker and separated from the first inclined surface at a different height;
a receiving portion in which the engaging piece is accommodated to fix the locker; and
a protruding piece having a shape obliquely bent at one edge of the receiving portion.

4. The door lock device of claim 2, wherein the second bridge includes a lifting protrusion having an edge protruding in an oblique form that lifts and lowers a certain region of the latch.

5. The door lock device of claim 1, wherein the operation of the first motor is controlled to maintain a locked state when a temperature is equal to or higher than a predetermined first reference temperature by a temperature sensor.

6. The door lock device of claim 1, wherein the operation of the second motor is controlled to automatically open the door when a temperature is equal to or lower than a predetermined second reference temperature by a temperature sensor.
